(19) United States
(12) Patent Application Publication
(10) Pub. No.: US 2018/0127040 A1
(43) Pub. Date: May 10, 2018

(54) ELECTRIC BICYCLE

(71) Applicant: FORD GLOBAL TECHNOLOGIES, LLC, Dearborn, MI (US)

(72) Inventor: Marcel MATHISSEN, Wuerselen NRW (DE)

(73) Assignee: FORD GLOBAL TECHNOLOGIES, LLC, Dearborn, MI (US)

(21) Appl. No.: 15/695,586

(22) Filed: Sep. 5, 2017

(30) Foreign Application Priority Data
Sep. 5, 2016 (DE) 10 2016 216 746.4

(51) Int. Cl. B62H 5/10; B62M 6/45; B62J 99/00

(52) U.S. Cl. CPC B62H 5/10; B62J 2099/004; B62J 99/00; B62M 6/45

(57) ABSTRACT

The disclosure relates to an electric bicycle. The electric bicycle comprises an electric motor for at least temporarily assisting or replacing a pedal operation. Assigned to the electric bicycle are at least two keys equipped with different rights, which differ from each other with respect to operating modes of the electric bicycle permitted in conjunction with a relevant key. One of the keys is an administrator key equipped with expanded rights. The expanded rights of the administrator key aids to provide a determination from a plurality of particular operating modes implementable for each of a remaining key from the at least two keys.

### CROSS-REFERENCE TO RELATED APPLICATIONS

This application claims foreign priority benefits under 35 U.S.C. § 119(a)-(d) to DE Application 10 2016 216 746.4 filed Sep. 5, 2016, which is hereby incorporated by reference in its entirety.

### TECHNICAL FIELD

The present disclosure relates to an electric bicycle.

### BACKGROUND

Electric bicycles assist the rider using an electric drive, and, depending on the linguistic usage and design, are also referred to as a “pedelec” or an “e-bike”.

The market for electric bicycles is in a strong growth phase, in which new pieces of additional equipment are being continuously developed, in particular in order to increase safety. A problem that occurs in this case in practice, however, is that, as the number of pieces of additional equipment increases, it becomes increasingly difficult for the user to retain an overview of the individual (in particular safety-relevant) equipment features. In this case, the user can be tempted, in particular, to deactivate certain functions. This, in turn, can pose a problem for bicycle rental companies, in particular, and for parents who would like to ensure that certain (e.g. safety-relevant) functions of the bicycle are always activated.

U.S. Pat. No. 8,738,212 B1 describes, inter alia, an electronically configurable electric bicycle, wherein, by way of using a mobile processor that comprises, inter alia, a GPS system that ascertains the present position of the electric bicycle, a maximum permissible power output of the electric bicycle is determined, which takes place, inter alia, on the basis of the determination of statutory provisions that apply for the present location. In this case, user-specific values for certain control parameters of the electric bicycle, such as, e.g., motor output power, motor torque or speed, can also be received, wherein the mobile processor can limit the control parameters to the relevant user-specific values.

US 2010/0228405 A1 describes, inter alia, a management system for a plurality of electric bicycles, wherein the electric bicycles are secured via a locking mechanism provided on sides of a charging station and can be electronically released by the management system according to user identification or on the basis of an authorization.

From DE 10 2009 023 097 A1 it is known, inter alia, to grant the driver of a motor vehicle the permission to enter data into a passenger communication device depending on whether this driver is a primary driver or a secondary driver.

GB 2495138 A describes, inter alia, a retaining device for a key for a bicycle lock, wherein the device can be fastened, e.g. on the handlebar stem, and releases the key only in response to an authorization signal entered by a user or retrieved from a management system.

### SUMMARY

A problem addressed by the present disclosure is that of providing an electric bicycle, which makes it possible, in a user-specific or personalized way, to ensure increased operational safety.

In the case of an electric bicycle according to the disclosure, the electric bicycle comprises an electric motor for the at least temporary assistance or replacement of a pedal operation. Assigned to the electric bicycle are at least two keys equipped with different rights, which differ from each other with respect to the operating modes of the electric bicycle permitted in conjunction with the relevant key.

In this case, one of the keys is an administrator key equipped with expanded rights, with the aid of a determination of the particular operating modes implementable for each of the remaining keys.

According to one embodiment, the keys differ from each other with respect to the particular deactivatability of at least one safety function of the electric bicycle that is possible in conjunction with the relevant key.

According to one embodiment, the keys differ from each other with respect to the possible extent of assistance by the electric bicycle that is possible in conjunction with the relevant key.

According to one embodiment, the electric bicycle is configured to counteract a pedal operation of the electric bicycle in at least one operating mode in the absence of use of a proper key of the electric motor.

According to one embodiment, the electric bicycle is configured to enable the electric bicycle only to be ridden in pedal operation, without assistance by the electric motor, in at least one operating mode in the absence of use of a proper key.

According to one embodiment, the electric bicycle is configured to activate or enable the activation of at least one predetermined safety system, in particular all safety systems present on the electric bicycle, in at least one operating mode in the absence of use of a proper key.

According to one embodiment, the rights belonging to each of the keys are established in a database, wherein contents of this database can be stored in or retrieved from a memory located on the electric bicycle or in an external cloud memory.

Further embodiments of the disclosure are found in the description and in the dependent claims.

The disclosure is explained in greater detail in what follows on the basis of preferred embodiments and with reference to the attached figures, wherein:

### BRIEF DESCRIPTION OF THE DRAWINGS

FIG. 1 shows an example of a database for the personalized operation of an electric bicycle which has been set up or stored according to the disclosure;

FIGS. 2A-B show schematic representations for illustrating the mode of operation of an electric bicycle according to a first embodiment; and

FIGS. 3A-B show schematic representations for illustrating the mode of operation of an electric bicycle according to a further embodiment.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

In one embodiment of an electric bicycle according to the disclosure, which is described in what follows, at least two different keys are provided, in particular, wherein one of these keys is a key equipped with expanded rights (“administrator key”) and the other key is a key equipped with rights that are limited with respect to the administrator key (user key). In this case, the administrator key allows, in particular, programming of certain functions that can be utilized for the particular electric bicycle in conjunction with a certain user key.

The disclosure is not limited further with respect to the specific embodiment of these keys, wherein these can be, in particular, actual physical keys or wireless communication devices (e.g. on the basis of RFID, WLAN, near-field communication, etc.) or signals generated thereby.

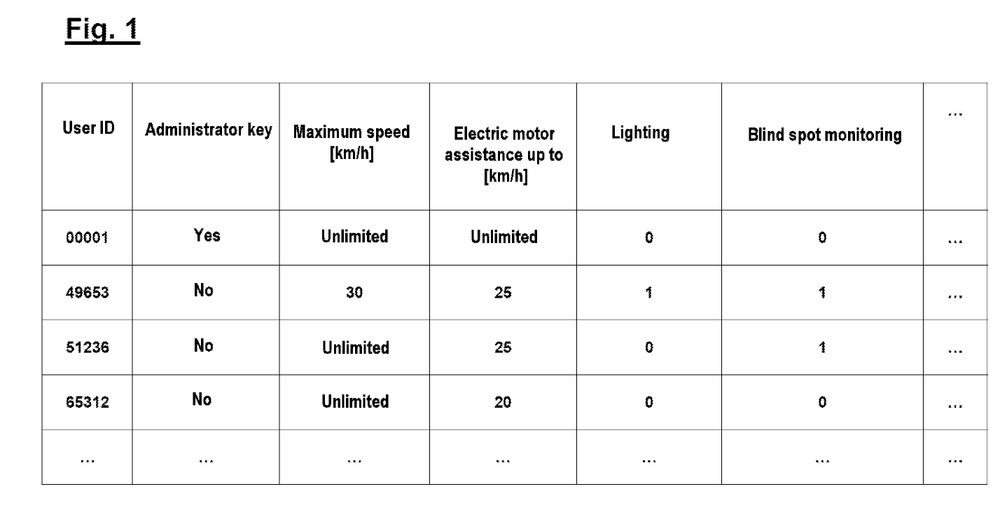

FIG. 1 shows an exemplary database in a table, which contains different requirements stored for a plurality of keys (one administrator key and three different user keys in the example).

According to FIG. 1, specified for a user having the user identification (=ID) “49653” is a maximum speed of 30 km/h and a maximum speed for the electric motor assistance up to 25 km/h, wherein the driving light and a blind spot monitoring device must also be switched on at all times (symbolized by “1”).

For a user having the user identification “51236”, however, there is no requirement that the driving light be switched on (symbolized by “0”), nor has a maximum vehicle speed been predetermined, wherein a limiting speed for the electric motor assistance of 25 km/h and permanently switched-on blind spot monitoring are also predetermined in this case.

The permanent activation of the blind spot monitoring also does not apply for the user having the user identification “65312”, however, wherein the maximum speed for the electric motor assistance has been set to 20 km/h in this case.

The administrator key having the user identification “00001” therefore has expanded rights as compared to the user keys, since no limiting values are predetermined for the maximum vehicle speed or the electric motor assistance, wherein the driving light and blind spot monitoring may also be deactivated.

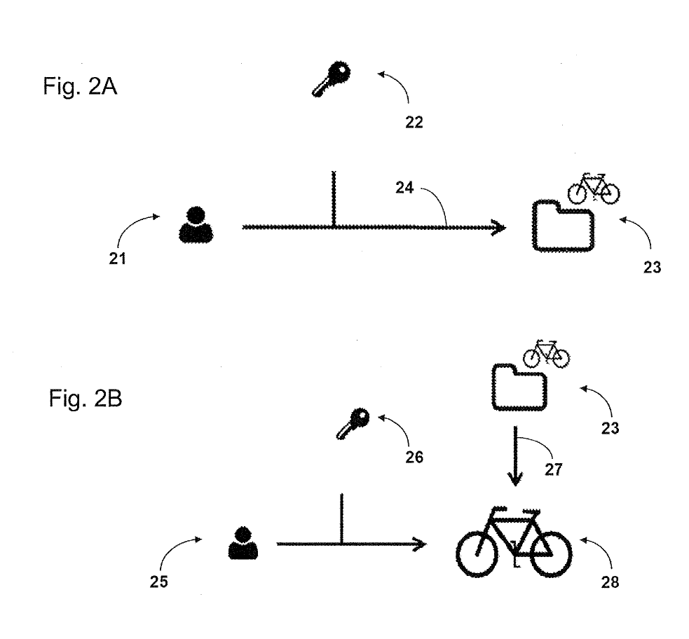

According to a first embodiment, which is schematically represented in FIGS. 2A-B, the contents of this database can be stored directly in the electric bicycle itself (e.g. with the use of a permanent memory).

FIG. 2A shows the configuration, by an administrator 21 having an administrator key 22 equipped with expanded rights, by means of a write access (indicated by an arrow “24”) to the relevant database or the contents 23 assigned to the particular users. FIG. 2B shows the read-out (indicated by an arrow “27”), by the user 25, of the corresponding user-specific settings or database entries 23 stored on the electric bicycle 28 with the use of a user key 26 equipped with rights that are limited as compared to the administrator key 22.

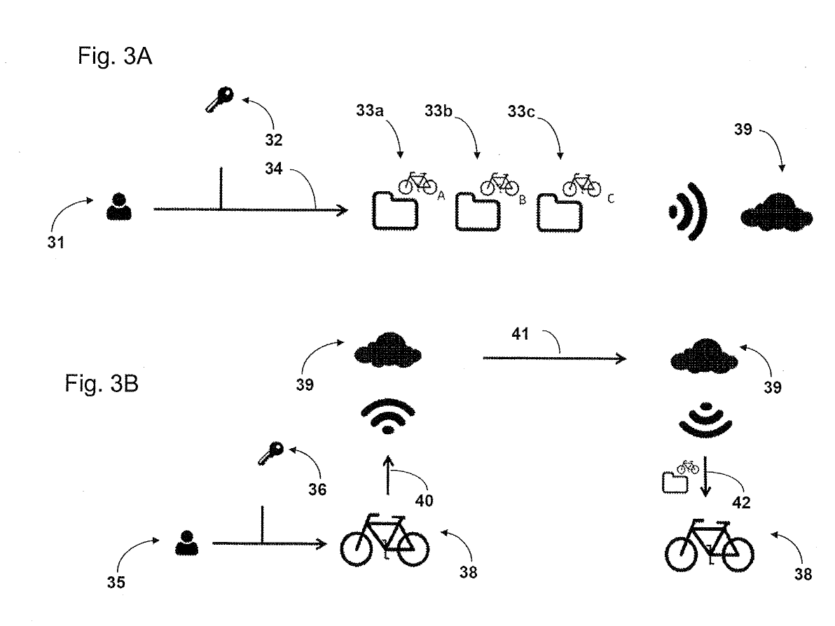

According to one further embodiment schematically represented in FIGS. 3A-B, the database or the contents 33a, 33b, 33c, assigned to the particular users can also be stored in a cloud memory 39, wherein the electric bicycle (labeled “38” in FIG. 3B) in this case is equipped with a device for wireless data transmission.

According to FIG. 3A, the establishment or configuration of the user-specific settings by an administrator 31 having an administrator key 32 equipped with expanded rights also takes place via a write access (indicated by an arrow “34”) in this case, wherein the corresponding contents of the database are stored in the cloud memory 39 or on a cloud server. As soon as a certain user key (e.g. the user key of a user 35 labeled “36” in FIG. 3B) is inserted, the electric bicycle 38 establishes communication with the relevant cloud memory 39 in order to download the particular user settings. The wireless communication taking place in this case comprises, according to FIG. 3B, uploading the corresponding user identification that retrieves the user settings (arrow “40”), looks up the user identification (“Lookup”, arrow “41”), and downloads the relevant user settings (arrow “42”).

In alternative embodiments, the database can be updated regularly, wherein the newest available data are used in each case. As a result, problems can be avoided in situations in which a connection cannot be established.

While the embodiment described above with reference to FIGS. 2A-B is suitable, in particular, for parents who would like to ensure that their children use the electric bicycle with the scope of safety functions that are suitable for the particular situation, the second implementation described with reference to FIGS. 3A-B is suitable, in particular, for bicycle rental businesses that have a large number of electric bicycles and for which it is not practical to individually program every single electric bicycle. In the latter case, the bicycle rental business can also provide, for example, personalized rental offers (e.g. granting the option to make full use of the entire 25-km/h power output of the electric bicycle for an additional fee).

In further embodiments, the utilization of the electric bicycle can also be recorded in a report file or an appropriate memory card. Based thereon, for example, the regular use of the safety helmet can be discussed between parents and children, or an insurance company can monitor the compliance with certain contractual conditions.

According to one further aspect of the disclosure, one or more measures can be taken for the case in which a proper key is not utilized. In this case, for example, an assistance by the electric motor can be deactivated while, simultaneously, all safety systems are switched on. In one alternative embodiment, the electric motor can also counteract the pedal operation, whereby the electric bicycle is shut off or is rendered immobile.

In this case, the disclosure also contains embodiments, in particular, in which the electric bicycle also remains usable, in principle, even in the absence of a proper key, wherein, in this case, e.g. only a failsafe mode without electric motor assistance is permitted. According to the disclosure, in particular, the above-described, personalized requirement of individual safety functions (see table 1) can be combined with an immobilization of the electric bicycle or a limitation to a failsafe operating mode without electric motor assistance in the absence of a proper key.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. An electric bicycle comprising:
a memory storing requirements for at least two keys equipped with different rights, the requirements specifying different operating modes of the electric bicycle permitted in conjunction with each of the keys, wherein one of the keys is defined as an administrator key equipped with expanded rights such that the expanded rights aid in a determination of a particular operating mode being implementable from any remaining keys.

2. The electric bicycle as claimed in claim 1, wherein the relevant key is defined by deactivatability of at least one safety function of the electric bicycle.

3. The electric bicycle as claimed in claim 1 further comprising an electric motor configured to assist a pedal operation such that the relevant key is defined by activatablility of the electric motor to assist the pedal operation.

4. The electric bicycle as claimed in claim 3, wherein the electric motor is configured to counteract the pedal operation in at least one operating mode in the absence of the relevant key defining rights to the at least one operating mode.

5. The electric bicycle as claimed in claim 3, wherein, in the absence of the relevant key in at least one operating mode, the pedal operation is without assistance by the electric motor.

6. The electric bicycle as claimed in claim 1, wherein, in the absence of the relevant key in at least one operating mode, the administrator key, via the expanded rights, is configured to activate at least one predetermined safety system.

7. The electric bicycle as claimed in claim 1, wherein each of the different rights belonging to each of the keys are established in a database, wherein contents of this database can be stored in and retrieved from a memory.

8. The electric bicycle as claimed in claim 7, wherein the memory is connected to a body of the electric bicycle.

9. The electric bicycle as claimed in claim 7, wherein the memory is disposed in an external cloud.

10. An electric bicycle control system comprising:
a memory storing requirements for two keys equipped with different rights, and different operating modes based on a relevant key corresponding to one of the different rights and an administrator key equipped with expanded rights to determine a particular operating mode being implementable from the relevant key; and
a motor configured to assist a pedal operation, operate based on the particular operating mode of the relevant key.

11. The electric bicycle control system as claimed in claim 10, wherein the relevant key is defined by deactivatability of a safety function.

12. The electric bicycle control system as claimed in claim 10, wherein the motor is configured to counteract the pedal operation in one of the different operating modes in the absence of the relevant key defining rights to the particular operating mode.

13. The electric bicycle control system as claimed in claim 10, wherein, in the absence of the relevant key in the particular operating mode, the pedal operation is without assistance by the motor.

14. The electric bicycle control system as claimed in claim 10, wherein, in the absence of the relevant key in the particular operating mode, the administrator key, via the expanded rights, is configured to activate a predetermined safety system.

15. The electric bicycle control system as claimed in claim 10, wherein the memory is disposed in an external cloud.

16. A bicycle identification system comprising:
an electric bike with a memory having relevant and administrator keys equipped with different rights, and different operating modes, the relevant key corresponding to one of the different rights and the administrator key equipped with expanded rights to determine a particular operating mode being implementable from the relevant key, and a motor activateable from the relevant key that operates based on the particular operating mode and assists a pedal operation.

17. The electric bicycle identification system as claimed in claim 16, wherein the relevant key is defined by deactivatability of a safety function.

18. The electric bicycle identification system as claimed in claim 16, wherein the motor is configured to counteract the pedal operation in one of the different operating modes in the absence of the relevant key defining rights to the particular operating mode.

19. The electric bicycle identification system as claimed in claim 16, wherein, in the absence of the relevant key in the particular operating mode, the pedal operation is without assistance by the motor.

20. The electric bicycle identification system as claimed in claim 16, wherein, in the absence of the relevant key in the particular operating mode, the administrator key, via the expanded rights, is configured to activate a predetermined safety system.
